(19) United States
(12) Patent Application Publication
(10) Pub. No.: US 2016/0136482 A1
(43) Pub. Date: May 19, 2016

(54) DEVICES, SYSTEMS, AND METHODS FOR PROVIDING FEATURES TO IMPROVE ACTIVITY SPORT SESSIONS

(71) Applicants: Mark West Askew, Jr., San Francisco, CA (US); Shane Alexander Farmer, San Francisco, CA (US); Joseph John Hebenstreit, San Francisco, CA (US); Zachary Barringer Scott, Santa Cruz, CA (US)

(72) Inventors: Mark West Askew, Jr., San Francisco, CA (US); Shane Alexander Farmer, San Francisco, CA (US); Joseph John Hebenstreit, San Francisco, CA (US); Zachary Barringer Scott, Santa Cruz, CA (US)

(21) Appl. No.: 14/946,614

(22) Filed: Nov. 19, 2015

Related U.S. Application Data
(60) Provisional application No. 62/081,757, filed on Nov. 19, 2014.

(51) Int. Cl. A63B 24/00; G01C 19/00; G01C 17/02; G01S 19/19; G01C 5/06

(52) U.S. Cl. CPC A63B 24/0062; G01S 19/19; G01C 5/06; G01C 17/02; G01C 19/00

(57) ABSTRACT

Several methods, devices and systems that provide features for improved activity sport sessions are described. In one embodiment, a multifunctional device includes an inertial measurement unit to sense movements of an activity device (e.g., a board, a surfboard, a windsurfing board, etc.) during an activity sport session and to sense at least one input for indicating a target location during the activity sport session. The device also includes at least one processing unit coupled to the inertial measurement unit. The at least one processing unit is configured to designate a target location in response to the inertial measurement unit sensing an input for indicating the target location, to record the target location, to determine a current location of the activity device, and to compare the current location and the target location. In one example, the at least one processing unit is further configured to generate a directional output if the target location and current location are different.

### RELATED APPLICATIONS

This application claims the benefit of U.S. Provisional Application No. 62/081,757, filed on Nov. 19, 2014, the entire contents of which are hereby incorporated by reference.

### TECHNICAL FIELD

Embodiments of the invention are generally related to devices, systems, and methods for providing features to improve activity sport sessions.

### BACKGROUND

Surfing is a sport dependent on ambient and environmental conditions. To determine the right time and place to surf, surfers need both real-time and historical data on waves and weather conditions at a planned surfing location. However, surfers must currently rely on limited historical data and limited real-time data. The available data shows previous conditions at a single beach location or limited set of beach locations. However, these specific locations with available data often do not coincide with the location where the surfer plans to surf based on the surfer's estimation of where the best waves and conditions will be found.

Surfing is also a social sport. A great part of the enjoyment that surfers derive from their outings comes from sharing these outings with other people. However, surfers are currently limited in their ability to share their surf sessions with others. To watch the surfer in real-time, a person must be present in-person or by webcam. To learn about the surfer's session after the event, a person can only view photographic evidence and hear or read descriptions of the session.

### SUMMARY

Several methods, devices and systems for monitoring and sharing session data are described. In one embodiment, a multifunctional device includes an inertial measurement unit to sense movements of an activity device (e.g., a board, a surfboard, a windsurfing board, a kite surfing board, a wake board, skiis, paddle board, etc.) during an activity sport session and to sense at least one input for indicating a target location during the activity sport session. The multifunctional device also includes at least one processing unit coupled to the inertial measurement unit. The at least one processing unit is configured to designate a target location in response to the inertial measurement unit sensing an input for indicating the target location, to record the target location, to determine a current location of the board, and to compare the current location and the target location.

In one example, the multifunctional device optionally includes a global position unit (GPS) to determine coordinates of the target location and to determine coordinates of the current location.

In another example, the at least one processing unit is further configured to determine whether the target location and the current location are approximately the same or different.

In another example, the at least one processing unit is further configured to generate a directional output if the target location and current location are different.

In another example, the inertial measurement unit includes a magnetometer to obtain a direction for the directional output to move from the current location to the target location.

In another example, the multifunctional device further comprises a display device to display the directional output to indicate a direction of movement for moving from the current location to the target location.

In another example, the input comprises at least one tap or knock for indicating the target location for a sport activity session.

In another example, the activity device is associated with a user for the activity sport session and the multifunctional device is coupled or in close proximity to the activity device or the user during the activity sport session.

In another example, the activity device comprises at least one of a surfboard, a kite surfing board, a windsurfing board, a wake board, and a paddle board.

In another example, the inertial measurement unit comprises an accelerometer for sensing acceleration data, a gyroscope for sensing angular velocity data, and a magnetometer for sensing magnetic field or directional data.

In another example, the multifunction device further comprises a pressure sensor used to calculate relative altitude, a light sensor for detecting ambient light levels, and temperature sensors for measuring air temperature and water temperature.

In another example, the at least one processing unit is configured to determine a turn force during a state of riding a wave by converting acceleration data to gravity force data.

In one embodiment, a computer implemented method comprises collecting data during an activity sport session by utilizing different sensors of a device including a global position system (GPS), an inertial measurement unit, and a pressure sensor. The method further includes identifying first and second positions of a movement during the activity sport session based on analysis of the collected data, determining with the device relative positions between the first and second positions based on acceleration data, and determining with the device orientation of a user while between the first and second positions based on orientation data.

In another example, the method further includes constructing a three dimensional (3D) ride visualization based on the relative positions and orientation of the user during the activity sport session.

In another example, the relative positions and orientation of the user during the activity sport session are determined based on data sensed by a 3-axis accelerometer, a 3-axis gyroscope, a 3-axis magnetometer, a barometer, and the GPS.

In another embodiment, a system, comprises an activity session system to store and process data for activity sport sessions. The system includes a multifunctional device coupled to the activity session system via a network. The multifunctional device includes an inertial measurement unit to sense movements of a board during an activity sport session and to sense at least one input for indicating a target location during the activity sport session. At least one processing unit of the multifunctional device is configured to designate a target location in response to the inertial measurement unit sensing the at least one input for indicating the target location, to record the target location, to determine a current location of a user or activity device (e.g., board), and to compare the current location and the target location.

In another example, the multifunctional device further comprises a global position unit (GPS) to determine coordinates of the target location at a first time and to determine coordinates of the current location at a second time.

In another example, the at least one processing unit is further configured to determine whether the target location and the current location are approximately the same or different and to generate a directional output if the target location and current location are different.

In another example, the system further comprises a camera-mounted flying drone communicatively linked to the multifunctional device. The drone captures video of a user of the board during the activity sport session.

In another example, the at least one processing unit is configured to transmit a current location of the user and associated activity device (e.g., board) to the drone and to provide instructions to the drone to follow the user and begin capturing video when a triggering event occurs (e.g., a user drops into a wave, a user jumps a wave, a user needs help, etc.). In another example, the board comprises at least one of a surfboard, a kite surfing board, a windsurfing board, a wake board, and a paddle board.

Other embodiments are also described. Other features of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 illustrates a multifunctional device for providing features for sport activity sessions in accordance with one embodiment.

FIG. 2 illustrates a flow diagram in one embodiment of the present invention for a computer-implemented method 200 for utilizing a position finding function to find a specific location.

FIG. 3 illustrates a flow diagram in one embodiment of the present invention for a computer-implemented method 300 for providing a three dimensional (3D) ride visualization.

FIG. 4 illustrates a sequences of images for a 3D ride visualization in accordance with one embodiment.

FIG. 5 shows an example of a system for monitoring and sharing session data for activity sport sessions in accordance with one embodiment.

FIG. 6 shows an example of a system for monitoring and sharing session data for activity sport sessions in accordance with one embodiment.

### DETAILED DESCRIPTION

Several methods, devices and systems for providing features for improved activity sport sessions are described. In one embodiment, a multifunctional device includes an inertial measurement unit to sense movements of an activity device (e.g., a board, a surfboard, a windsurfing board, a kite surfing board, a wake board, skiis, paddle board, etc.) during an activity sport session and to sense at least one input for indicating a target location during the activity sport session. The device also includes at least one processing unit coupled to the inertial measurement unit. The at least one processing unit is configured to designate a target location in response to the inertial measurement unit sensing an input for indicating the target location, to record the target location, to determine a current location of the activity device, and to compare the current location and the target location.

In one example, the at least one processing unit is further configured to generate a directional output if the target location and current location are different. A display device displays the directional output to indicate a direction of movement for moving from the current location to the target location.

Although athletes of water sport activities (e.g., surfers, windsurfers, kite surfers, etc.) would like the ability to show others real-time data on the athletes' sessions (e.g., surfers' sessions) the equipment for easily doing this is not available. If real-time data could be recorded, athletes (e.g., surfers) would have additional information and evidence to assist in sharing their exploits with other athletes (e.g., surfers). This data would also make possible a better method of scoring athletic (e.g., surfing) competitions. Currently, athletic (e.g., surfing) competitions rely heavily on subjective judgments that can make it difficult to reach consensus for judging quantitative performance parameters (e.g., on a wave, surf accomplishments, and awards). Additionally, athletes (e.g., surfers) would like to better record details about their individual athletic (e.g., surfing) sessions for their own personal analysis. However, athletes (e.g., surfers) are currently limited to after-the-fact approximations of such statistics as their speed, direction, and the length of a particular wave. Having this information would help surfers track their abilities and accomplishments over time, and it would help surfers hone their skills and also find and return to the best surfing locations.

In one embodiment, a device records and transmits data on multiple parameters of a sports session (e.g., surfer's surf session). This data provides both real-time and post event assistance to the surfer in executing current and future surf sessions, in analyzing surf sessions, and in sharing surf session data with others. In one example, the device attaches to the surfer or the surfboard and collects data on position, heading, water temperature, air temperature, barometric pressure, acceleration, orientation and ambient light. Uses of the device and collected data include providing real-time directions to a surfer for returning to a specific water location, enabling the surfer to act as a near-shore buoy recording and transmitting wave and weather conditions, acting as an emergency beacon, and collecting data and session statistics for personal assessment, socially competitive sharing, and assisting in the judging of surf competitions.

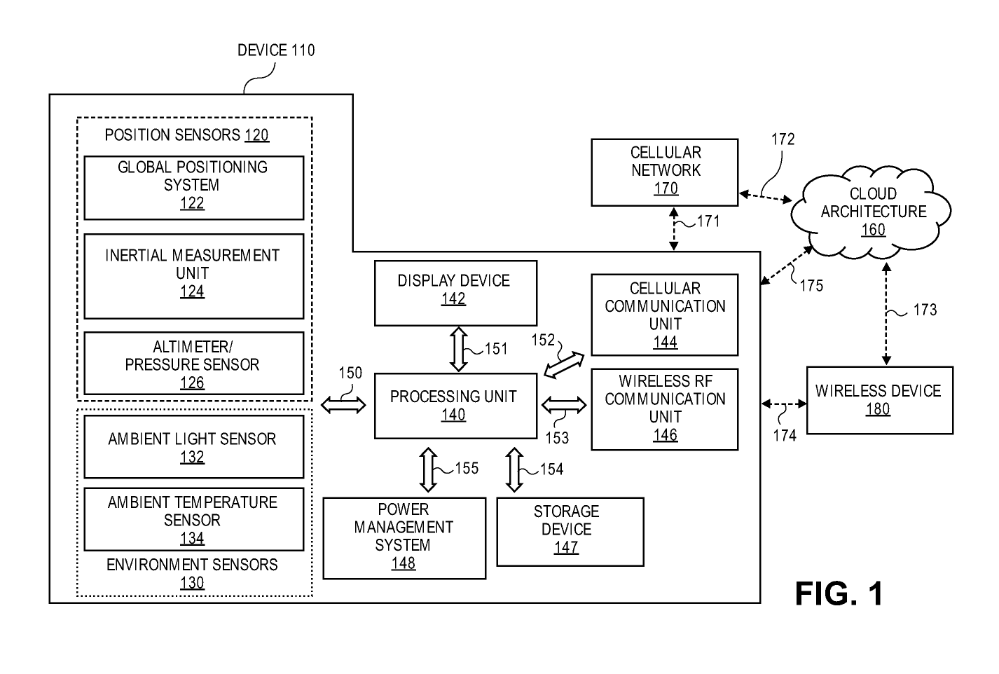

FIG. 1 illustrates a multifunctional device for providing features for sport activity sessions in accordance with one embodiment. The device 110 is coupled to a cellular network 170 and a cloud architecture 160 (e.g., internetwork, Internet, wide area network, etc.). A wireless device 180 (e.g., mobile device, tablet device, wearable device, any type of smart device, flying drone device, etc.) is also coupled to the cloud architecture 160. The devices 110 and 180 may be directly coupled to the cloud architecture 160 or indirectly coupled via the cellular network 170. The device 110 collects and processes data for a sport session in real time and can transmit this data in real time to the cellular network 170, wireless device 180, or directly to the cloud architecture 160. The device 110 can also receive data in real time from the cellular network 170, cloud architecture 160, and wireless device 180.

The device 110 includes positions sensors 120 and environment sensors 130. The position sensors 120 include a first position-sensing component 122 (e.g., a global positioning system 122 having an antenna), which calculates a real-time location of the device 110. A second position sensing component 124 (e.g., an inertial measurement unit 124) includes, in one example, a 3-axis accelerometer, a 3-axis gyroscope, and a 3-axis magnetometer. In one example, the magnetometer measures the strength and in some cases, the direction of a magnetic field at a point in space. This inertial measurement unit 124 in combination with the one or more processing units 140 can detect all movements during a session (e.g., movements of user, movements of a surfer, movements of surfboard, etc.). Movements may be caused by a wave, wind, or maneuvers made by the user (e.g., surfer) as well as inputs (e.g., taps, knocks) created by the user's fingers by detecting sudden large and small changes in the device's position in Earth's magnetic field, acceleration, and gyroscopic orientation. A third position-sensing component 126 (e.g., altimeter, pressure sensor) includes a pressure sensor used to calculate relative altitude. Environmental sensors 130 include ambient light sensor(s) 132 (e.g., photodiode sensor) for detecting ambient light levels and ambient temperature sensor(s) 134 for measuring air temperature and water temperature.

In one example, one or more processing units 140 includes a micro-controller unit that controls and monitors the sensors and other device components. The one or more processing units 140 (e.g., micro-controller unit) includes a processor, memory, and an instruction set. The processing units 140 are communicatively coupled to the position sensors 120 and environmental sensors 130 via communication link 150. A power management system 148 is communicatively coupled to the processing units 140 via a communication link 155. The power management system 148 includes a power source (e.g., battery, solar cell) for powering the device 110. The power management system 148 optimizes an amount of time that the device is operable before the power source needs to be recharged.

In one example, the power management system 148 includes a lithium polymer battery in combination with standard electronics that monitor the battery charge and prevent it from dropping below a critical level. Storage device 147 (e.g., memory, solid-state or magnetic memory, flash memory) is connected to the processing units 140 with communication link 154 and used to store data collected by sensors or other data. The storage device 147 stores data and/or operating programs for the device 110. Storage device 147 may be or include a machine-readable medium.

A machine-readable medium includes any mechanism for storing or transmitting information in a form readable by a machine (e.g., a computer). For example, machines store and communicate (internally and with other devices over a network) code and data using machine-readable media, such as machine storage media (e.g., magnetic disks; optical disks; random access memory; read only memory; flash memory devices; phase-change memory).

The device may optionally include an image sensor (e.g., CCD (Charge Coupled Device), CMOS sensor). The image sensor may be integrated with an image processing unit. The device may also includes an imaging lens which can be optically coupled to image sensor. The at least one processing unit 140 controls the image processing operation and controls the storage of a captured image in storage device 147.

A display device 142 is connected to the processing units 140 via communication link 151 and used to display information to a user of the device (e.g., user during a sport session). In one embodiment, the display device includes an addressable led array. In another embodiment, the display device includes a segmented or active matrix type display. In another embodiment, the display device includes an input/output device (e.g., touchscreen).

A RF wireless communication component or unit 146 includes a transceiver and an antenna for transmitting and receiving wireless communications (e.g., Bluetooth, WiFi, Zigbee, etc.) via communication link 174 to another wireless device 180 (e.g., smart phone, mobile device, tablet device, smart watch, wearable device, any smart device, laptop, computer, etc.) or via communication link 175 to the cloud architecture 160. The unit 146 is coupled to the processing units 140 via communication link 153. In one example, the RF wireless communication component 146 allows for a connection to a smart phone with wireless communications (e.g., Bluetooth, WiFi, Zigbee, etc.) via communication link 174 to send and receive data at any time (e.g., before an activity sport session, after an activity sport session, etc.).

Additionally, a wireless cellular communication unit 144 (or chip) includes a transceiver and antenna to transmit and receive real-time data to computer systems and devices using communication link 171 and local wireless telecommunications network 170, which is coupled to cloud architecture 160 via a communication link 172. The device 110 can also communication with a cloud architecture 160 (e.g., internetwork, Internet, wide area network) via communication link 175.

In one embodiment, a user communicates with the device through interacting with the device (e.g., user input, tapping the device with the user's fingers in specific patterns, knocking, voice commands, etc.). In another embodiment, the user communicates with the device through pressing a button. In each case of interacting with the device, specific patterns of user inputs activate different features. In one embodiment, a first user input (e.g., two taps or button presses) changes a functional mode of the device, a second user input (e.g., three taps or button presses) marks or records a current location of the device so that the user may later be guided back to that location. A third user input (e.g., six taps or button presses) triggers an emergency beacon.

In one example, the device 110 is attached to the surfer (e.g., wearable device, clothing) or the surfboard at the start of a sport activity session (e.g., surf session, windsurfing session, kiteboarding session). The device includes multiple functionality for collecting, transmitting, and storing data on multiple parameters during the session using the device sensors. An absolute position and heading of the user are detected using the GPS system. The inertial measurement unit and altimeter-pressure sensor additionally assist in refining the user's location and provide additional data on the user's movements, including the user's heading, acceleration, and orientation. The air and water temperature is collected using the temperature sensors. The barometric pressure is collected using the altimeter pressure sensor. Ambient light levels are detected using a photodiode sensor. Data on these parameters is processed by the micro-controller before being stored in the on-board flash memory. Each parameter's data is tracked and stored over time from the start to the end of the surfer's surf session. The device therefore stores the entire sequence of locations, movements, and ambient conditions collected by the device during each session.

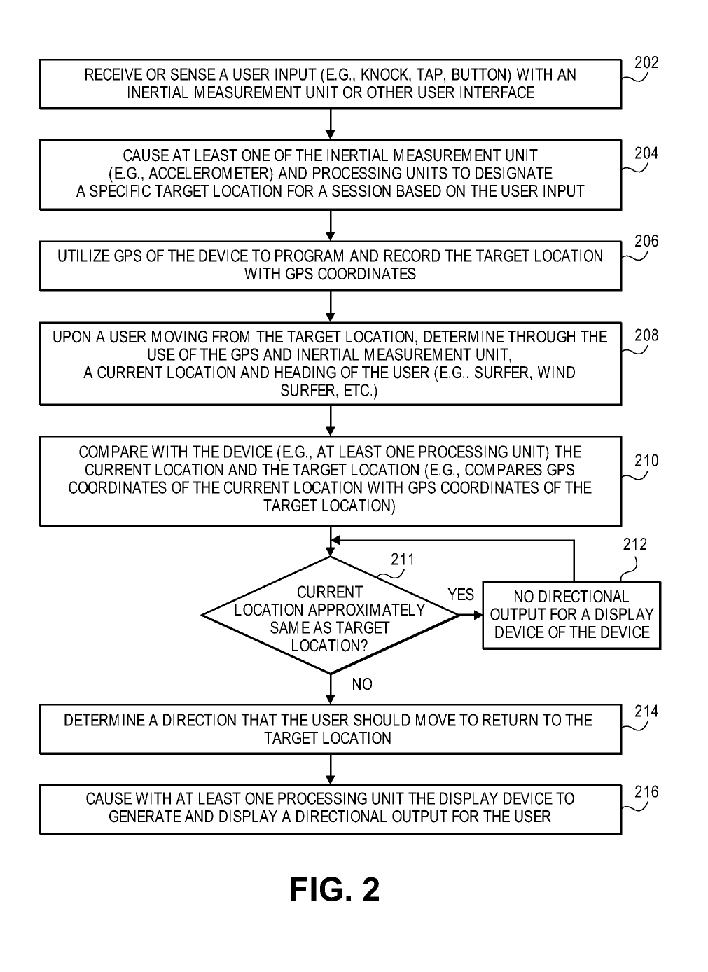

The device provides multiple functionality including a position finding function to find a specific location that the user was at previously. FIG. 2 illustrates a flow diagram in one embodiment of the present invention for a computer-implemented method 200 for utilizing a position finding function to find a specific location. The computer-implemented method 200 is performed by processing logic that may comprise hardware (circuitry, dedicated logic, etc.), software (such as is run on a general purpose computer system or a dedicated machine or a system), or a combination of both. In one example, the device 110 having one or more processing units 140 and different sensors performs the operations of the method 200.

At operation 202, a user input (e.g., knock, tap, button) is received or sensed by the inertial measurement unit (e.g., accelerometer) or other user interface. At operation 204, the detection of this user input (e.g., a series of knock or taps from the user, press of a button, etc.) causes at least one of the inertial measurement unit (e.g., accelerometer) and the processing units to designate a specific target location where the user input was received because the user desires to return to this target location later. For example, an athlete of a water sport may desire to designate a specific location having desirable characteristics (e.g., waves, peak of wave, wind direction, wind speed, etc.) for a sport session. At operation 206, the device then utilizes a GPS to program and record that target location with GPS coordinates. Once the user has moved from that recorded target location, the device, through the use of the GPS and inertial measurement unit, then determines the current location and heading of the user (e.g., surfer, windsurfer, etc.) at operation 208. Through use of the processing logic (e.g., one or more processing units) at operation 210, the device compares the current location and the target location (e.g., compares GPS coordinates of the current location with GPS coordinates of the target location.

At operation 212, if the current location and the target location are approximately the same (e.g., +/−10 feet, +/−9 feet, +/−3 feet, within 10 feet of each other, within 5 feet of each other, etc.), then the processing logic (e.g., one or more processing units) does not generate a directional output for a display device of the device. In this case, the method can return to operation 211 to monitor whether the current location differs from the target location.

At operation 214, if the current location and the target location are different (e.g., current and target locations separated by at least 3 feet, current and target locations separated by at least 5 feet, current and target locations separated by at least 10 feet, etc.) , then the processing logic (e.g., one or more processing units) determines a direction that the user should move to return to the target location. A compass functionality (e.g., magnetometer) of the inertial measurement unit may be utilized to obtain a direction to move from the current location to the target location. At operation 216, the processing logic (e.g., one or more processing units) causes the display device to generate and display a directional output for the user. The directional output (e.g., an arrow, a series of arrows, one or more cardinal directions, etc.) indicates a direction that the user needs to move to return to the target location.

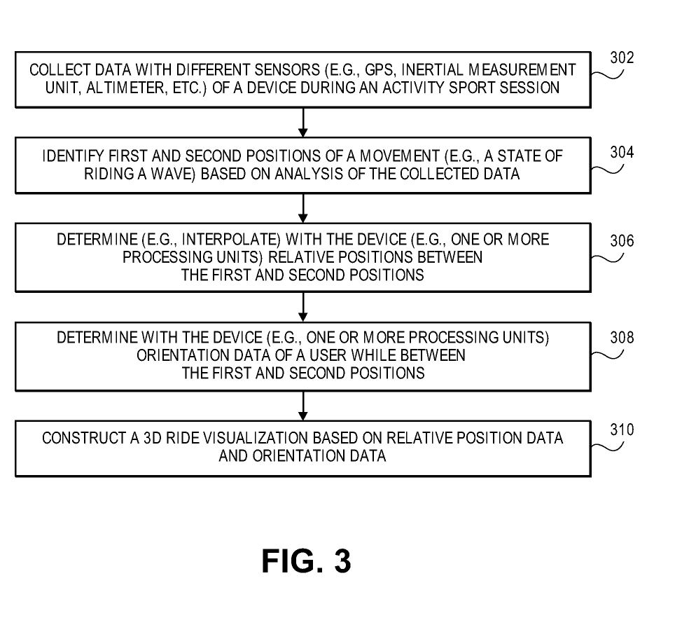

FIG. 3 illustrates a flow diagram in one embodiment of the present invention for a computer-implemented method 300 for providing a three dimensional (3D) ride visualization. The computer-implemented method 300 is performed by processing logic that may comprise hardware (circuitry, dedicated logic, etc.), software (such as is run on a general purpose computer system or a dedicated machine or a system), or a combination of both. In one example, the device 110 having one or more processing units 140 and different sensors performs the operations of the method 300.

At operation 302, data from a device is collected by different sensors (e.g., GPS, inertial measurement unit, altimeter, etc.) during an activity sport session. At operation 304, first and second positions of a movement (e.g., a state of riding a wave) are identified by analysis of the collected data. At operation 306, the device (e.g., one or more processing units) interpolates relative positions between the first and second positions (e.g., between absolute GPS positions associated with the first and second positions). In one example, the device interpolates the relative positions (e.g., dead reckoning) based on calculating a double integral of data sensed by an accelerometer during the movement from the first to second positions. Altitudes of the user (or surfboard) at the first and second positions and also altitudes during the movement from the first position to the second position may also be used in determining the relative positions.

At operation 308, the device (e.g., one or more processing units) determines orientation of a user (or activity device (e.g., a board)) while between the first and second positions (e.g., between absolute GPS positions associated with the first and second positions). In one example, the orientation of the user (or activity device) while between absolute positions associated with the first and second positions is determined based on orientation data of the user (or activity device) at the first and second positions and also orientation data during the movement from the first position to the second position. A gyroscope may provide the orientation data. In one example, data obtained by a 3-axis accelerometer, a 3-axis gyroscope, a 3-axis magnetometer, a barometer, and a GPS may be utilized in determining relative position and orientation data for constructing a 3D ride visualization at operation 310.

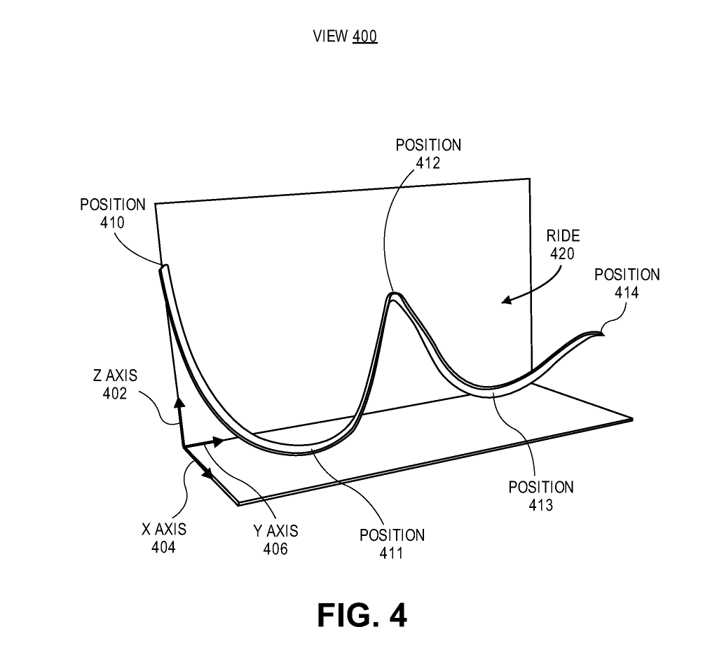

FIG. 4 illustrates a view of a 3D ride visualization in accordance with one embodiment. The view 400 is oriented with respect to a coordinate space having z axis 402, y axis 406, and z axis 404. A surfer moves from an initial position 410 to position 411 to position 412 to position 413 to position 414 for an example of a ride 420. A surfer can turn near position 412. The multifunction device can track data relating to this session throughout the ride 420 in order to generate various metrics and the 3D ride visualization. For example, data obtained by a 3-axis accelerometer, a 3-axis gyroscope, a 3-axis magnetometer, a barometer, and a GPS may be utilized in determining relative position and orientation data for constructing a 3D ride visualization 420. In one example, the barometer provides an absolute altitude for each position (e.g., xyz space) and the GPS provides absolute GPS coordinates for each position (e.g., xyz space). The inertial measurement unit can then interpolate to obtain positions and orientation data between these positions (e.g., positions 410, 411, 412, 413, 414, etc.).

The multifunction device can provide additional features in accordance with the methods 200 and 300 or in addition to these methods. In one embodiment, a multifunction device determines a speed in which a user moves from a first position to a second position (e.g., during a state of riding a wave). A speed is calculated based on determining a distance and time elapsed between first and second positions.

In another example, the multifunction device can determine a turn force during a state of riding a wave. The multifunction device determines the turn force by converting acceleration data (e.g., acceleration in meters/second2) to gravity (G) force data. Acceleration data is obtained from an accelerometer having an axis that is orthogonal to a velocity vector during a state of riding a wave. An accelerometer and gyroscope may be utilized in determining the turn force.

In another example, the multifunction device can determine a barrel time which is defined as a time elapsed during a rapid increase in barometric pressure data when accelerometer and GPS data indicate a wave is being ridden by the user. An accelerometer, barometer, and GPS may be utilized in determining the barrel time.

In another example, the multifunction device can determine a wave height when an accelerometer and GPS data indicate a wave is being ridden by the user. A lowest pressure recorded, which correlates to altitude above sea level, indicates a wave height. An accelerometer, barometer, and GPS may be utilized in determining the wave height time.

In another example, the multifunction device can determine a hold down time when an accelerometer and GPS data indicate a wave is being ridden by the user. A hold down time is defined as a time elapsed during an event in which an accelerometer measures oscillations of acceleration primarily along one axis that is also parallel to earth's normal force of gravity as measured by a magnetometer. This axis is also parallel to a longitudinal axis of a surfboard. An accelerometer, gyroscope, and magnetometer may be utilized in determining the hold down time.

In another example, the multifunction device can determine an air time when an accelerometer and GPS data indicate a wave is being ridden by the user. An air time is defined as a time elapsed between an first event of acceleration along a certain vector, followed by a momentary second event of zero acceleration, and followed by a third event of acceleration that is approximately equal but inverse to the first event (e.g., having parabolic or sinusoidal motion) during a state of riding a wave. An accelerometer and gyroscope may be utilized in determining the air time.

In another example, the multifunction device can determine a jump height during an air time event when an accelerometer and GPS data indicate a wave is being ridden by the user. A jump height is defined as a highest altitude measured above sea level during an air time event. An accelerometer and barometer may be utilized in determining jump height during the air time event.

In another example, the multifunction device can determine a swell height in absence of a paddling and wave riding event. A swell height is defined as a highest altitude measurement from a barometer. A swell height event is triggered by a low frequency sinusoidal motion signature in acceleration data in absence of paddling event and wave riding event. An accelerometer, gyroscope, magnetometer, and barometer may be utilized in determining swell height.

In another example, the multifunction device can determine a swell period. A swell period is defined as a time elapsed between two successive measurements of swell height within a range of a certain time period (e.g., 1-30 seconds). An accelerometer, barometer, and gyroscope may be utilized in determining swell height.

In another example, the multifunction device can determine a number of waves per set. Waves per set is defined as a sum of successive events of swell height precluded and followed by an elapsed time of a multiple (e.g., 2, 3, etc.) of the swell period before a next closest swell height event. An accelerometer, barometer, and gyroscope may be utilized in determining swell height.

In another example, the multifunction device can determine a set lull time. The set lull time is defined as a time elapsed between a first measured wave set event and a subsequent or next second wave set event. An accelerometer, gyroscope, magnetometer, and barometer may be utilized in determining the set lull time.

In another example, the multifunction device can determine a crowd factor. Given a certain region or area, a crowd factor is calculated for a number of surfers per the certain region or area. A GPS and cellular communication unit may be utilized in determining the crowd factor.

In another example, the multifunction device can determine a current that indicates a speed and a direction of water movement. In the absence of a paddling or a wave riding event, a speed and direction are calculated by a time elapsed and change in distance between coordinates (e.g., GPS coordinates) of a first position and second position. An accelerometer, GPS, and cellular communication unit may be utilized in determining the current.

In another example, the multifunction device can determine a paddle distance which is defined during a paddle event as an oscillatory rotational motion about a longitudinal axis of a board (e.g., surf, paddle, etc.) in combination with a sustained low speed (e.g., speed less than a certain threshold, paddle speed, etc.) as measured by a GPS. An accelerometer, gyroscope, and GPS may be utilized in determining the paddle distance.

In another example, the multifunction device can determine a ride distance which is defined during a state of a wave ride event to be a distance between a first position and a second position. The ride distance event is triggered at a first position when a sudden acceleration occurs as measured by an accelerometer and an increase in speed occurs as measured by a GPS. The ride distance event ends at a second position when a sudden deceleration occurs as measured by an accelerometer and a decrease in speed as measured by a GPS. An accelerometer and GPS may be utilized in determining the ride distance.

In another example, the multifunction device can determine a ride duration during a ride event. The ride duration is defined during a state of a wave ride event to be a time elapsed between a first position and a second position of the wide ride event. The ride duration event is triggered at a first position when a sudden acceleration occurs as measured by an accelerometer and an increase in speed occurs as measured by a GPS. The ride duration event ends at a second position when a sudden deceleration occurs as measured by an accelerometer and a decrease in speed (e.g., decrease in speed to approximately zero) as measured by a GPS. An accelerometer and GPS may be utilized in determining the ride distance.

In another example, the multifunction device can determine a number of waves ridden which is defined to be a sum of wave events. A wave event is triggered at a first position when a sudden acceleration occurs as measured by an accelerometer and an increase in speed occurs as measured by a GPS. The wave event ends at a second position when a sudden deceleration occurs as measured by an accelerometer and a decrease in speed (e.g., decrease in speed to approximately zero) as measured by a GPS. An accelerometer and GPS may be utilized in determining the wave events.

In another example, the multifunction device can determine a number of waves missed or number of waves paddled in terms of a sum of events. An event is defined to be a burst of higher frequency (e.g., ?at least 1.2 Hz oscillation, at least 1.4 Hz oscillation, etc.) oscillatory rotational motion about a longitudinal axis of a board in combination with a low speed (e.g., 2.5 mph or less) as measured by GPS. An event is not followed by a wave riding event. In one example, a surfer averages approximately 60 strokes per minute when not paddling for a wave and approximately 80 strokes per minute when paddling for a wave. Each stroke correlates to a roll (or oscillation of the board) such that a higher frequency indicates paddling for a wave.

An additional use of the GPS coordinates of the device is to guide a camera-mounted flying drone to capture video of the user surfing. Many surfers would like to capture video of their surfing, with the most common way to capture this video being mounting a camera to a surfboard. This results in limited camera angles for capturing the surfer and can also limit the surfer's ability to surf. A recent alternative to get around these problems has been to have camera-mounted quad-copter drones (or other UAVs) hovering at popular beach breaks ready to capture video of a surfer. A surfer using the present design can link the device to a network that is used to control a camera-equipped drone. The present design then uses this network to transmit the surfer's current location to the drone. The device can be programmed to provide instructions to the linked drone to follow the surfer and begin capturing video when the surfer drops into a wave.

A state of riding a wave is determined by the inertial measurement unit and barometer detecting movement and pressure changes consistent with riding a wave crest or with entering and exiting a hollow wave.

The surfer also uses the device to act as a buoy transmitting real-time wave and weather conditions for availability to other surfers. The data from the inertial measurement unit, GPS, and altimeter-pressure sensor is processed by the one or more processing units (e.g., microcontroller) to determine a swell period, a swell speed, a wave height, time between sets of waves, and general water surface conditions. The data from temperature sensors, altimeter-pressure sensor, and light sensor is processed by the micro-controller to give selected current weather conditions. Once processed, the collected data is stored for later analysis and can also be transmitted in real-time through a wireless RF communication unit or cellular communication chip to other devices that are set up to receive the data. The device can additionally act as an emergency beacon when needed, such as when the surfer is accidentally swept out to sea out-of-sight of land.

In one embodiment, a user input (e.g., pressing a button) in a specific pattern or for a certain duration is designed to initiate an emergency beacon function. In another embodiment, a user input (e.g., taps) for communication includes inputting a specific pattern to initiate the emergency beacon function. Once activated, the device as an emergency beacon uses its GPS and RF wireless communication component to broadcast the surfer's location to local emergency services.

In conjunction with the one or more processing units, the device customizes the emergency broadcast frequencies used and messages transmitted to the locality (e.g., country, state, region, beach, location, etc.) in which the surfer is located.

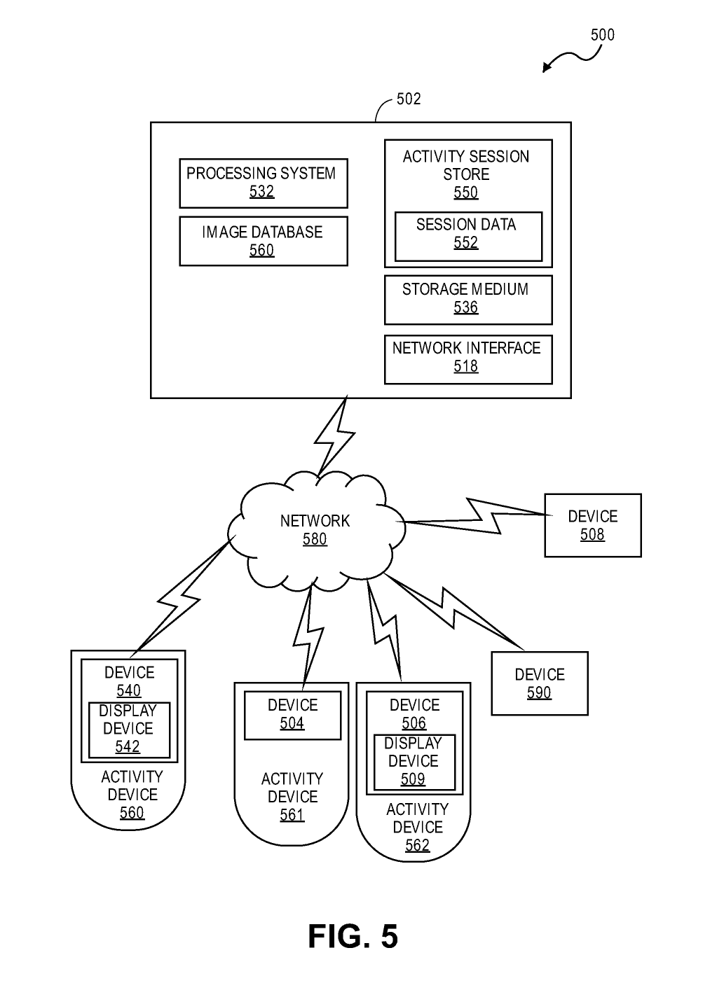

FIG. 5 shows an example of a system for monitoring and sharing session data for activity sport sessions in accordance with one embodiment. For example and in one embodiment, the system 500 may be implemented as a cloud based system with servers, data processing devices, network elements, etc. Aspects, features, and functionality of the system 500 can be implemented in servers, multifunction devices, data tracking devices, laptops, tablets, computer terminals, client devices, user devices, wearable devices, handheld computers, personal digital assistants, cellular telephones, cameras, smart phones, mobile phones, computing devices, or a combination of any of these or other data processing devices.

In other embodiments, the system includes a network computer or an embedded processing device within another device (e.g., display device) or other types of data processing systems having fewer components or perhaps more components than that shown in FIG. 5.

The system 500 (e.g., cloud based system) for monitoring and sharing session data of activity sport sessions includes devices 540, 504, 506, and 508 for monitoring and sharing activity sport session data of activity sports (e.g., surfing, windsurfing, kiteboarding session, etc). The device 540, 504, and 506 are associated with or coupled to activity devices 560, 561, and 562, respectively. The activity devices may include at least one of boards, surfboards, windsurfing boards, kite surfing boards, wake boards, skiis, etc. Each of these devices may include display devices (e.g., display devices 542, 509) even if a display device is not shown in FIG. 5. A wireless device 590 (e.g., mobile device, flying drone device, etc.) is also coupled to the network 580. The devices can include similar features and functionality in comparison to the device 110 including position sensors and environmental sensors. The system 500 includes an activity session analysis system 502 that includes an activity sport session store 550 with current and historical session data and at least one processing system 532 for executing instructions for performing activity sport session analysis of the session data. The storage medium 536 may store instructions, software, software programs, etc for execution by the processing system and for performing operations of the activity session analysis system 502. An image database 560 stores captured images of activity sports for different session data.

In one embodiment, the processing system is configured to execute instructions to receive session data, process session data, monitor session data, and transmit session data when requested.

The system 500 shown in FIG. 5 may include a network interface 518 for communicating with other systems or devices such as drone devices, user devices, and data tracking devices that track session data during an activity sport session via a network 580 (e.g., Internet, wide area network, WiMax, satellite, cellular, IP network, etc.). The network interface include one or more types of transceivers for communicating via the network 580.

The processing system 532 may include one or more microprocessors, processors, a system on a chip (integrated circuit), or one or more microcontrollers. The processing system includes processing logic for executing software instructions of one or more programs. The system 500 includes the storage medium 536 for storing data and programs for execution by the processing system. The storage medium 536 can store, for example, software components such as a software application for monitoring and sharing session data among a group or network of users. The storage medium 536 can be any known form of a machine readable non-transitory storage medium, such as semiconductor memory (e.g., flash; SRAM; DRAM; etc.) or non-volatile memory, such as hard disks or solid-state drive.

While the storage medium (e.g., machine-accessible non-transitory medium) is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present disclosure. The term “machine-accessible non-transitory medium” shall accordingly be taken to include, but not be limited to, solid-state memories, optical and magnetic media, and carrier wave signals.

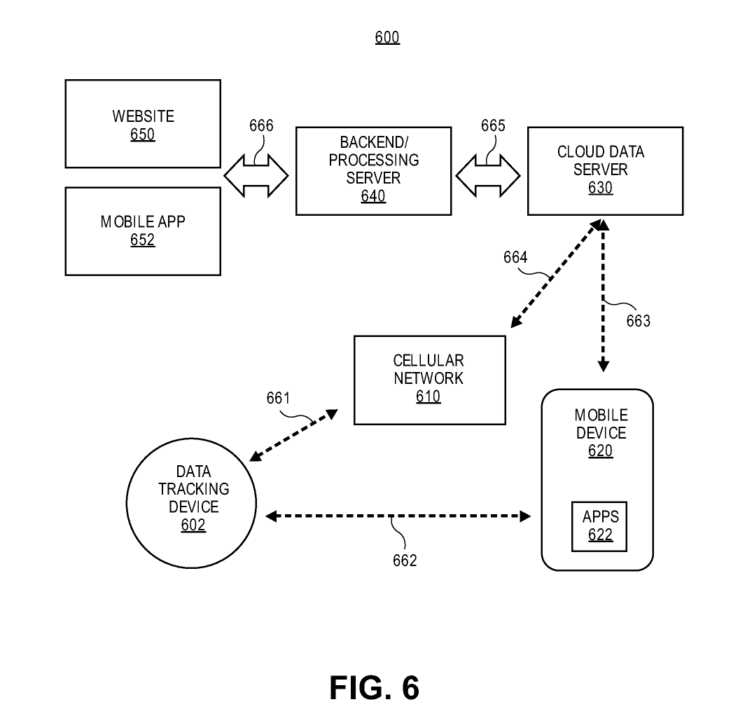

FIG. 6 shows an example of a system for monitoring and sharing session data for activity sport sessions in accordance with one embodiment. The system 600 includes a data tracking device 602 (e.g., device 110, device 540, device 504, device 508, device 508, etc.), a cellular network 610, a mobile device 620 having mobile applications 622, a cloud data server 630, a backend processing server 640, a website module 650, and a mobile application 652. These devices, network, and servers communicate via communication links 661-666.

In one embodiment, the device 602 collects session data during activity sport sessions and then sends this collected data to a computer system (e.g., cloud data server 630, backend processing server 640) for data analysis. This data can be shared with others via any network (e.g., cellular, wide area network, local area network, social network, etc.). The data collected by the device is transmitted by a wireless telecommunication component, either in real-time as the data is collected or after the sport session is over using the data saved to the flash storage (e.g., storage device 147) to an external computer system for further processing and sharing with others. This computer system may be any type of computer system (e.g., a smartphone, a personal computer, etc.). In one example, a dedicated application is used by the user (e.g., surfer) to showcase the data in visual form. The application gives a graphical presentation of the parameters collected. This allows the user to see the entire range of data available for a single parameter over the course of a session (e.g., surf session), such as the range of surface water temperatures encountered, as well as the minimum and maximum point for that parameter, such as the maximum and minimum water temperature. For a given calculation, such as the speed of the surfer at each moment in the surf session, the application can either use measurements calculated by the device's on-board microcontroller or can process the raw data received from the device to calculate its own measurements. These calculations based on the data collected by all the sensors are then displayed in a graphical presentation to the user. For a calculation, such as the speed of the surfer, the entire range of values as well as the minimum and maximum are shown to the surfer. The surfer can therefore easily find noteworthy points from the surf session, such as when the surfer reached maximum speed, performed a trick or maneuver, or wiped out. The tracked location data and other parameter data and calculations are also overlaid on a map of the surf area, making it easy to see the individual rides and where noteworthy events from the surf session occurred. The user can additionally use this map feature of the application to select a location where the user would like to surf in the future and then send that location to the device via the RF wireless communication component before a surf session. The device's way-finding feature (e.g., position finding function) can then be used to guide the user to the pre-programmed location.

Still referring to FIG. 6, the computer software application (e.g., mobile app 622) that has downloaded, processed, and displayed the collected data then uploads the data, calculations, and visual presentation of the results to a cloud data server 630 where it may be made accessible to other users having computer software applications via a backend common processing server and the other users' use of the computer application via a website 650 or dedicated mobile application 652. The user additionally has the option of uploading the device data directly to the cloud data server 630 from the device via the wireless cellular network chip and antenna.

In one example, each application user is assigned or chooses a unique user ID and can communicate with other users. Each user has the opportunity to make that user's uploaded data publically available to the application's other users. The users therefore form an online community where they can see data from other users' surf sessions and compare and compete for various results, such as the highest wave, distance paddled, time to paddle out, longest ride, longest hold down, longest session, highest and longest jumps, total tube time, and worst wipeout as defined by greatest sudden deceleration.

When the data is transmitted in real-time or near real-time, it can be used by judges in a surf competition to add objective criteria to their judgments of overall skill or a particular accomplishment. Even when users decline to make their data publicly accessible, anonymous data is still used by the application to calculate probable conditions at various locations. These condition predictions are then shared with the application's users to help the users find ideal surfing times and locations.

The data collected by the device would be used by the computer application to calculate and present various metrics, any of which could be shared by the user with the online community of other surfers. These metrics include the longest wave, which would be calculated by determining the longest relatively straight line continuously traveled at a speed greater than could be achieved by paddling. Other metrics include the turn force and angle, the air time, including the time in air during a jump, and the distance travelled in the air. In one example, a state of the user being airborne is determined probabilistically using the position-sensing components (e.g., position sensors 120) together. In another example, the number of waves caught, the hold down time, defined as an amount of time a wave held the user under water, the state of the user being underwater, are determined probabilistically using the position-sensing components, a photodiode sensor, and a temperature sensor together.

Additional metrics includes a biggest wipeout, defined as the greatest sudden deceleration of the user, the farthest vertical distance change on a wave, colloquially known as “drop in,” as defined by the amount of free fall time and pressure change, the amount of time to paddle out to a location, the time caught inside the impact zone as defined by paddling with no change in distance and distinct jostling signatures read by the accelerometer, the total distance surfed on a wave and the total distance paddled. A state of surfing instead of paddling can be determined probabilistically by the speed of the user in which a user surfs at a greater speed than a paddles.

Other metrics include the paddle and surfing speeds, the time inside each individual hollow wave and all the waves. A state of being inside a hollow wave is determined by a pressure sensor that detects barometric pressure changes consistent with entering and exiting a hollow wave. Metrics also include a wave height, a swell period, a time interval between sets, with a set defined as a group of organized waves that travel together with consistent intervals between their peaks. Such waves generally have a higher amplitude than disorganized waves which occur outside a set. The air and water temperature are additional metrics.

In the foregoing specification, the disclosure has been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A multifunctional device, comprising:
an inertial measurement unit to sense movements of an activity device during an activity sport session and to sense at least one input for indicating a target location during the activity sport session; and
at least one processing unit coupled to the inertial measurement unit, the at least one processing unit is configured to designate a target location in response to the inertial measurement unit sensing an input for indicating the target location, to record the target location, to determine a current location of the activity device, and to compare the current location and the target location.

2. The multifunctional device of claim 1, further comprising:
a global position unit (GPS) to determine coordinates of the target location at a first time and to determine coordinates of the current location at a second time.

3. The multifunctional device of claim 1, wherein the at least one processing unit is further configured to determine whether the target location and the current location are approximately the same or different.

4. The multifunctional device of claim 3, wherein the at least one processing unit is further configured to generate a directional output if the target location and current location are different.

5. The multifunctional device of claim 4, wherein the inertial measurement unit includes a magnetometer to obtain a direction for the directional output to move from the current location to the target location.

6. The multifunctional device of claim 4, further comprising:
a display device to display the directional output to indicate a direction of movement for moving from the current location to the target location.

7. The multifunctional device of claim 1, wherein the input comprises at least one tap or knock for indicating the target location for a sport activity session.

8. The multifunctional device of claim 1, wherein the activity device is associated with a user for the activity sport session and the multifunctional device is coupled or in close proximity to the activity device or the user during the activity sport session.

9. The multifunctional device of claim 1, wherein the activity device comprises at least one of a surfboard, a kite surfing board, a windsurfing board, a wake board, and a paddle board.

10. The multifunction device of claim 1, wherein the inertial measurement unit comprises an accelerometer for sensing acceleration data, a gyroscope for sensing angular velocity data, and a magnetometer for sensing magnetic field or directional data.

11. The multifunction device of claim 1, further comprising:
a pressure sensor used to calculate relative altitude;
a light sensor for detecting ambient light levels; and
temperature sensors for measuring air temperature and water temperature.

12. The multifunction device of claim 1, wherein the at least one processing unit is configured to determine a turn force during a state of riding a wave by converting acceleration data to gravity force data.

13. A computer implemented method comprising:
collecting data during an activity sport session by utilizing different sensors of a device including a global position system (GPS), an inertial measurement unit, and a pressure sensor;
identifying first and second positions of a movement during the activity sport session based on analysis of the collected data;
determining, with the device, relative positions between the first and second positions based on acceleration data; and
determining, with the device, orientation of a user while between the first and second positions based on orientation data.

14. The computer implemented method of claim 13 further comprising:
constructing a three dimensional (3D) ride visualization based on the relative positions and orientation of the user during the activity sport session.

15. The computer implemented method of claim 13 wherein the relative positions and orientation of the user during the activity sport session are determined based on data sensed by a 3-axis accelerometer, a 3-axis gyroscope, a 3-axis magnetometer, a barometer, and the GPS.

16. A system, comprising:
an activity session system to store data for activity sport sessions; and
a multifunctional device coupled to the activity session system via a network, the multifunctional device having an inertial measurement unit to sense movements of a board during an activity sport session, to sense at least one input for indicating a target location during the activity sport session, and at least one processing unit of the multifunctional device is configured to designate a target location in response to the inertial measurement unit sensing the at least one input for indicating the target location, to record the target location, to determine a current location of the board, and to compare the current location and the target location.

17. The system of claim 16, wherein the multifunctional device further comprises a global position unit (GPS) to determine coordinates of the target location at a first time and to determine coordinates of the current location at a second time.

18. The system of claim 17, wherein the at least one processing unit is further configured to determine whether the target location and the current location are approximately the same or different and to generate a directional output if the target location and current location are different.

19. The system of claim 16, further comprising:
a camera-mounted flying drone communicatively linked to the multifunctional device, the drone to capture video of a user of the board during the activity sport session.

20. The system of claim 19, wherein the at least one processing unit is configured to transmit a current location of the user and associated board to the drone and to provide instructions to the drone to follow the user and begin capturing video when a triggering event occurs.

21. The system of claim 16, wherein the board comprises at least one of a surfboard, a kite surfing board, a windsurfing board, a wake board, and a paddle board.
